(19) United States
(12) Patent Application Publication
(10) Pub. No.: US 2026/0228181 A1
(43) Pub. Date: Aug. 6, 2026

(54) GDSXOR COMPARSION WITH MACHINE LEARNING TO CLASSIFY CHANGES

(71) Applicant: GlobalFoundries U.S. Inc., Malta, NY (US)

(72) Inventors: Simona Milenova Dimitrova, Sofia (BG); Romain H.A. Feuillette, Williston, VT (US); Georgi Stoyanov Radkov, Sofia (BG); Toshko Todorov Miladinov, Sofia (BG); Aleks-Martin Konstantinov Lakovski, Sofia (BG); Kiril Ivanov, Sofia (BG); Bradley A. Orner, Ben Lomond, CA (US); Nolan James Pavek, Austin, TX (US); Farzana Akhter, Colorado Springs, CO (US); Nikola Ivanov Dinkov, Sofia (BG); Stephen Trevor Burgess, Sofia (BG)

(21) Appl. No.: 19/043,670

(22) Filed: Feb. 3, 2025

(51) Int. Cl. G06F 16/16; G06N 20/00

(52) U.S. Cl. CPC G06F 16/16; G06N 20/00

(57) ABSTRACT

A system and method for classifying changes between graphic design system (GDS) files using a machine learning (ML) model. A disclosed method includes: inputting a first GDS file and a second GDS file into a GDSXOR comparator to generate a differences file, wherein the differences file includes a plurality of changes between the first GDS file and a second GDS file; using the ML model to process changes in the differences file, wherein the ML model evaluates each change and outputs a probability that a change is at least one of expected or unexpected; and comparing the probability to a threshold and classifying the change as at least one of expected or unexpected in response to the threshold being met.

### TECHNICAL FIELD

The present disclosure relates generally to Exclusive Or (XOR) comparisons of graphic design system (GDS) files (i.e., GDSXOR comparisons), and more particularly to classifying GDSXOR changes using machine learning to detect expected versus unexpected changes.

### BACKGROUND

GDS files are database files that store component layouts for an integrated circuit (IC) chip including devices such as field effect transistors (FETs), resistors, capacitors, etc., or a set of interconnected devices. During the development steps, different iterations of a GDS file may be generated. For example, optimizations may be implemented to a GDS file to improve performance. Accordingly, a production ready GDS may differ from an original (e.g., golden) GDS specification.

### SUMMARY

All aspects, examples and features mentioned below can be combined in any technically possible way.

An aspect of the disclosure provides a system that includes a memory and a processor coupled to the memory and configured to classify changes between graphic design system (GDS) files using a machine learning (ML) model. Classification is implemented according to a process that includes: inputting a first GDS file and a second GDS file into a graphic design system exclusive or (GDSXOR) comparator to generate a differences file, wherein the differences file includes a plurality of changes between the first GDS file and a second GDS file; using the ML model to process changes in the differences file, wherein the ML model evaluates each change and outputs a probability that a change is at least one of expected or unexpected; and comparing the probability to a threshold and classifying the change as at least one of expected or unexpected in response to the threshold being met.

Another aspect of the disclosure provides a method for classifying changes between graphic design system (GDS) files using a machine learning (ML) model. The method includes: inputting a first GDS file and a second GDS file into a graphic design system exclusive or (GDSXOR) comparator to generate a differences file, wherein the differences file includes a plurality of changes between the first GDS file and a second GDS file; using the ML model to process changes in the differences file, wherein the ML model evaluates each change and outputs a probability that a change is at least one of expected or unexpected; and comparing the probability to a threshold and classifying the change as at least one of expected or unexpected in response to the threshold being met.

Two or more aspects described in this disclosure, including those described in this summary section, may be combined to form implementations not specifically described herein. The details of one or more implementations are set forth in the accompanying drawings and the description below. Other features, objects and advantages will be apparent from the description and drawings, and from the claims.

### BRIEF DESCRIPTION OF THE DRAWINGS

The embodiments of this disclosure will be described in detail, with reference to the following figures, wherein like designations denote like elements, and wherein:

FIG. 1 shows a system flow for evaluating changes in GDS files, according to embodiments of the disclosure;

FIG. 2 shows a GDS visualization system, according to embodiments of the disclosure;

FIG. 3 shows a high-level process flow for classifying changes, according to embodiments of the disclosure;

FIG. 4 shows a method for training a machine learning (ML) model, according to embodiments of the disclosure;

FIG. 5 depicts a method for classifying a list of changes using an ML model, according to embodiments of the disclosure; and

FIG. 6 depicts a computing system, according to embodiments of the disclosure.

It is noted that the drawings of the disclosure are not necessarily to scale. The drawings are intended to depict only typical aspects of the disclosure, and therefore should not be considered as limiting the scope of the disclosure. In the drawings, like numbering represents like elements between the drawings.

### DETAILED DESCRIPTION

In the following description, reference is made to the accompanying drawings that form a part thereof, and in which is shown by way of illustration specific illustrative embodiments in which the present teachings may be practiced. These embodiments are described in sufficient detail to enable those skilled in the art to practice the present teachings, and it is to be understood that other embodiments may be used and that changes may be made without departing from the scope of the present teachings. The following description is, therefore, merely illustrative.

Embodiments of the disclosure provide a system and process for identifying and classifying expected/unexpected changes between two graphic design system (GDS) files. As noted, a GDS file provides a layout to manufacture components, e.g., devices such a FET, resistors, capacitors, etc., (or a combination of devices) within an integrated circuit (IC) device or other semiconductor chip. A GDS file may be utilized to represent a cell stored in a cell library. A typical GDS file lifecycle begins with the creation of a chip layout design in an electronic design automation (EDA) tool, progresses through verification and optimization stages, and finally culminates in the GDS file being sent to a semiconductor foundry for fabrication, where it serves as the definitive blueprint for the physical chip layout, essentially marking the final stage of the design process before manufacturing begins. During the development cycle, intentional layout modifications are often made to the GDS file to improve performance. However, unexpected changes often result when the layout is modified, which could lead to errors or reduced performance when fabricating the component, e.g., due to shared code and resource constraints. In some cases, modifications to a layout can result in a very large number of changes, some expected and some unexpected. Identifying unexpected layout changes so that they can be addressed prior to manufacturing (or inclusion in a cell in a process design kits (PDK) library) is a technical challenge and extremely time consuming. In conventional practice, a subject matter expert may have to review thousands of changes and make educated decisions about each change, which adds to the time and cost of the fabrication process. This technical challenge is herein solved with the use of a machine learning (ML) model that is trained to classify changes, including classifying expected and/or unexpected changes.

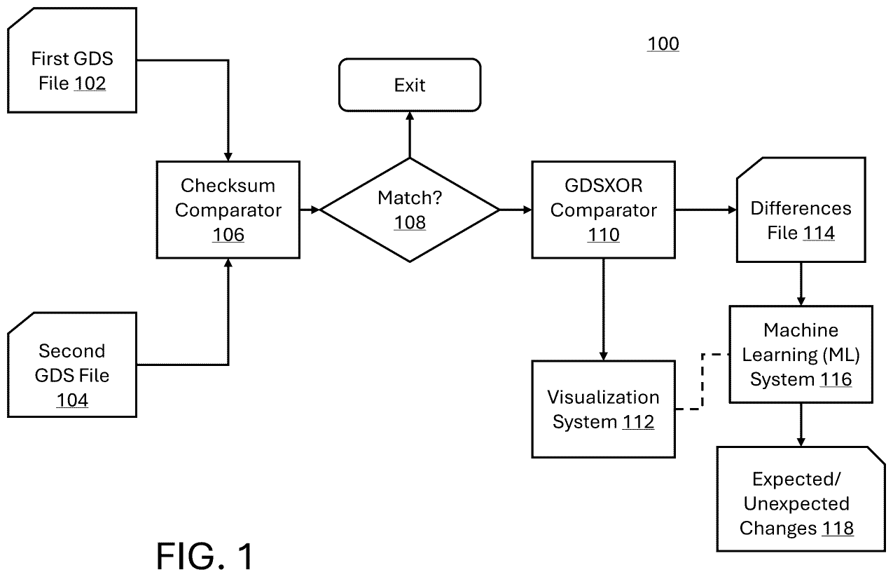

FIG. 1 depicts a system 100 that inputs a first (e.g., existing) GDS file 102 and a second (e.g., modified) GDS file 104 for a component layout. As noted, the component may include a device or set of devices. System 100 detects changes between the two, and classifies the changes, e.g., determines whether the changes are expected or unexpected. In this illustrative embodiment, the first GDS file 102 and second GDS file 104 are first fed to a checksum comparator 106 that compares the binary information of the two files. If the files 102, 104 match at 108 indicating that the files are identical and there are no changes, then the process exits. If the files 102, 104 do not match at 108, then the files are fed to a GDSXOR comparator 110 that identifies differences (i.e., changes) between the two files. GDSXOR comparator 110 may for example perform a cell-by-cell comparison of the two files 102, 104 and output a list of object differences based on a set of rules. GDSXOR comparator tools that compare layout designs of GDS files are known in the art, and therefore are not described in detail herein. The results of the GDSXOR comparator 110 may be fed into a visualization system 112, which allows a user to view images of and differences between layouts associated with a given cell. The results may also be output as a differences file 114 that includes a list of changes and associated image data, which is then processed by a machine learning (ML) system 116 to automatically classify changes, e.g., as expected or expected changes. In complex IC designs, the number of changes can be extremely large between the two inputted GDS files 102, 104 (e.g., thousands of changes). Identifying which of those changes are unexpected (e.g., potential errors) and expected can accordingly be a time-consuming process if done manually.

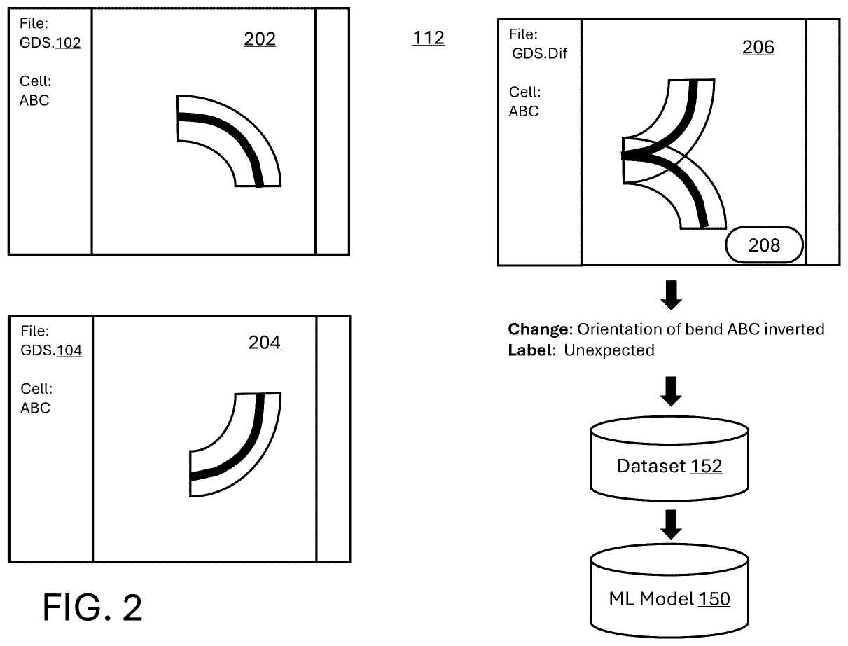

FIG. 2 depicts an example visualization system 112 with a visualization interface that shows an image of a cell 202 from the first GDS file (102) and an image of a changed cell 204 from the second modified GDS file (104). A third visualization 206 shows both cells in a single window highlighting the change between the two. In certain aspects, a classification option 208 is provided so that a user such as expert can manually classify the change and label/save the change to a dataset 152. The dataset 152 is in turn used to train a ML model 150.

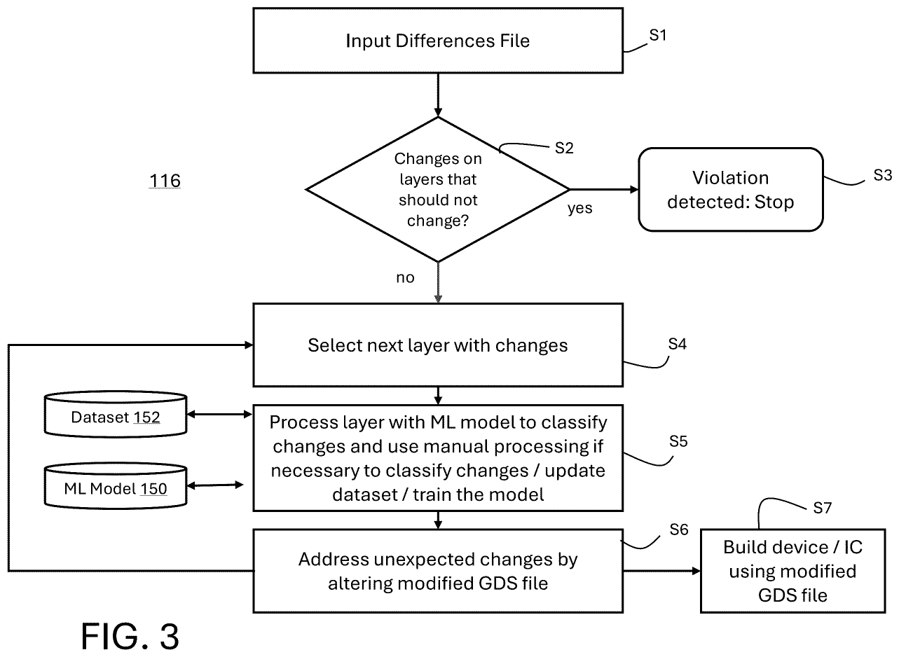

FIG. 3 depicts a high-level flow diagram of the ML system 116 being implemented with a trained model 150. The process begins at S1 with the input of the differences file 114 into the ML system 116, which may for example comprise a list of changes (including associated image data) between two GDS files. Next, at S2, a determination is made whether there are changes on any of the layers that should not change, e.g., they violate a set of rules. If such a violation is detected, the process stops at S3 and the issue can be addressed. Otherwise, a next layer having changes is selected at S4. At S5 changes within the selected layer are processed by the ML model 150, which includes classifying changes in the layer, e.g., as expected, unexpected, other, etc. For changes that cannot be classified by the model 150, manual processing is utilized to classify and label the change, and update the dataset 152, which is then used to further train the model 150. At S6, unexpected changes in the current layer of the modified GDS file 104 are addressed, e.g., by an engineer who redesigns the layout. The process repeats by selecting a next layer with changes at S4 until all layers have been processed. When the modified GDS 104 is finalized, i.e., all unexpected or otherwise problematic changes have been addressed, the modified GDS file 104 can be used as the layout to build an IC component.

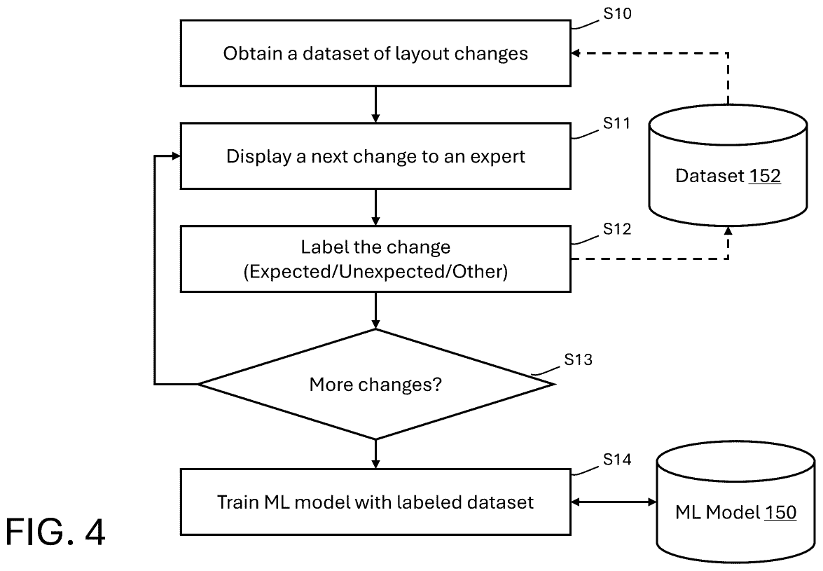

FIG. 4 depicts an illustrative process for initially training ML model 150 using supervised learning. Initially at S10 a dataset 152 of (unlabeled) layout changes is provided. Dataset 152 may be obtained from any source, e.g., existing GDSXOR differences files, etc. Next at S11, a layout change is presented to an expert, e.g., in the visualization system 112 of FIG. 2, and the expert classifies and labels the change. In one illustrative embodiment, the labels for each change may include expected, unexpected, and/or other labels. Other labels may for example include classifications such as “minor issue,” “further assessment recommended,” etc. The type and number of labels can vary depending on the particular application and desired granularity. At S13, if there are more changes in the dataset 152 requiring manual classification, the process displays a next change at S11 for labeling. If no additional changes exist in the dataset at S13, the ML model 150 can be trained with the labeled dataset at S14.

ML model 150 may be implemented in any manner. In one illustrative embodiment, ML model 150 comprises a Convolutional Neural Network (CNN) that classifies image data. The CNN can automatically learn and extract features from images, such as edges, textures, or shapes, which enable the model 150 to learn and make predictions (referred to as Feature Extraction). Accordingly, dataset 152 may include a set of images (each representing a possible change between two GDS files) and associated labels, which are used to train model 150, i.e., using supervised learning. For example, during training, an image of a change and label is inputted into the model 150 and a result is outputted. If the result matches the label, then the next change is inputted. If the result does not match the label, then the model 150 is adjusted.

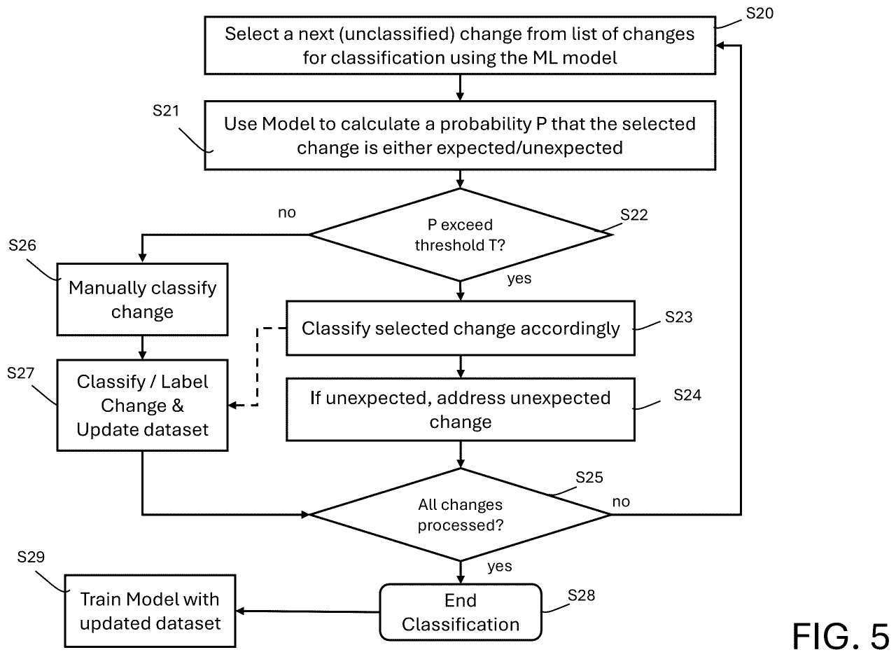

FIG. 5 depicts an illustrative process for using the trained model 150 to automatically classify a list of changes from a difference file 114 (FIG. 1), e.g., as expected, unexpected, unsure, etc. First, at S20, a next (unclassified) change is selected from the list of changes for automated classification by the ML model 150. At S21, the model 150 is used to calculate a probability, e.g., that the selected change is either expected or unexpected. For example, in a first case, the model 150 might predict that a given change is 82% likely to be unexpected. In a second case, the model 150 might predict that a given change is 15% likely to be unexpected. In a third case, the model 15 might predict that a given change is 50% likely to be unexpected. At S22, a determination is made whether the prediction P exceeds one or more thresholds T, e.g., above 85% indicating that the change is unexpected (first case) or below 15% indicating that the change is expected (second case). If a threshold is met at S23, the selected change is classified accordingly (e.g., as unexpected or expected). The result of the successful classification may additionally be added the dataset 152 at S27. At S24, if the change is unexpected (e.g., deemed potentially problematic or critical) the change can be addressed (e.g., by an engineer to revise the layout of the modified GDS file 104) at that time (or at a later time after all changes in the list are evaluated). If at S22, a threshold is not met, i.e., the classification of the change cannot be determined by the model 150 with a high enough level of probability, the change is manually classified at S26. This, for example, involves an expert to review the change using the visual interface of FIG. 2 to manually classify/label the change and update the dataset 152 with the labeled change at S27.

At S25, a determination is made whether all the changes have been processed and classified, i.e., either automatically by the model 150 or manually. If no at S25, then a next change is selected at S20 and the process repeats. If yes at S25, then the classification process for the list is complete at S28, i.e., all changes have been classified, e.g., as expected or unexpected. Additionally, at S29, the model 150 may be further trained with the updated dataset.

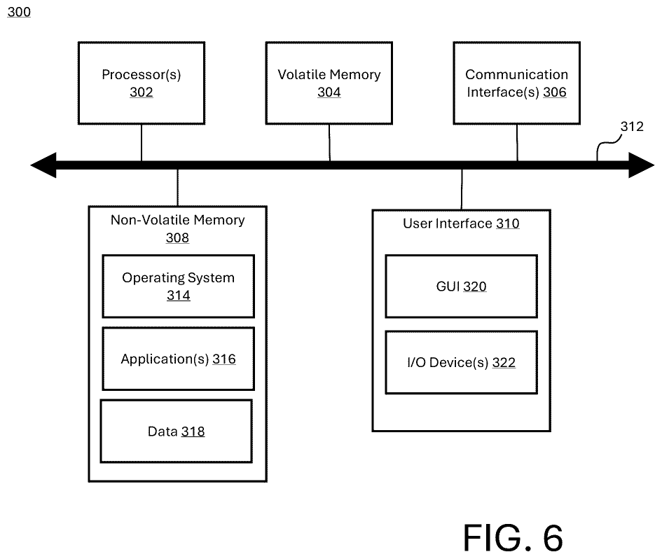

Elements of the described solution may be embodied in a computing system, such as that shown in FIG. 6 in which a computing device 300 may include one or more processors 302, volatile memory 304 (e.g., RAM), non-volatile memory 308 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 310, one or more communications interfaces 306, and communication bus 312. User interface 310 may include graphical user interface (GUI) 320 (e.g., a touchscreen, a display, etc.) and one or more input/output (I/O) devices 322 (e.g., a mouse, a keyboard, etc.). Non-volatile memory 308 stores operating system 314, one or more applications 316, and data 318 such that, for example, computer instructions of operating system 314 and/or applications 316 are executed by processor(s) 302 out of volatile memory 304. Data may be entered using an input device of GUI 320 or received from I/O device(s) 322. Various elements of computer 300 may communicate via communication bus 312. Computer 300 is shown merely as an example, as clients, servers and/or appliances and may be implemented by any computing or processing environment and with any type of machine or set of machines that may have suitable hardware and/or software capable of operating as described herein.

Processor(s) 302 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

Communications interfaces 306 may include one or more interfaces to enable computer 300 to access a computer network such as a LAN, a WAN, or the Internet through a variety of wired and/or wireless or cellular connections.

In described embodiments, a first computing device 300 may execute an application on behalf of a user of a client computing device (e.g., a client), may execute a virtual machine, which provides an execution session within which applications execute on behalf of a user or a client computing device (e.g., a client), such as a hosted desktop session, may execute a terminal services session to provide a hosted desktop environment, or may provide access to a computing environment including one or more of: one or more applications, one or more desktop applications, and one or more desktop sessions in which one or more applications may execute.

As will be appreciated by one of skill in the art upon reading the following disclosure, various aspects described herein may be embodied as a system, a device, a method or a computer program product (e.g., a non-transitory computer-readable medium having computer executable instruction for performing the noted operations or steps). Accordingly, those aspects may take the form of an entirely hardware embodiment, an entirely software embodiment, or an embodiment combining software and hardware aspects. Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof.

The terminology used herein is for the purpose of describing particular embodiments only and is not intended to be limiting of the disclosure. As used herein, reference in the specification to “one embodiment” or “an embodiment” of the present disclosure, as well as other variations thereof, means that a particular feature, structure, characteristic, and so forth described in connection with the embodiment is included in at least one embodiment of the present disclosure. Thus, the phrases “in one embodiment” or “in an embodiment,” as well as any other variations appearing in various places throughout the specification are not necessarily all referring to the same embodiment. It is to be appreciated that the use of any of the following “/,” “and/or,” and “at least one of,” for example, in the cases of “A/B,” “A and/or B” and “at least one of A and B,” is intended to encompass the selection of the first listed option (A) only, or the selection of the second listed option (B) only, or the selection of both options (A and B). As a further example, in the cases of “A, B, and/or C” and “at least one of A, B, and C,” such phrasing is intended to encompass the first listed option (A) only, or the selection of the second listed option (B) only, or the selection of the third listed option (C) only, or the selection of the first and the second listed options (A and B), or the selection of the first and third listed options (A and C) only, or the selection of the second and third listed options (B and C) only, or the selection of all three options (A and B and C). This may be extended, as readily apparent by one of ordinary skill in the art, for as many items listed. It will be further understood that the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event or circumstance may or may not occur, and that the description includes instances where the event occurs and instances where it does not. It will be further understood that when an element such as a layer, region, or substrate is referred to as being “on” or “over” another element, it may be directly on the other element or intervening elements may also be present. In contrast, when an element is referred to as being “directly on” or “directly over” another element, there may be no intervening elements present. It will also be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present.

Approximating language, as used herein throughout the specification and claims, may be applied to modify any quantitative representation that could permissibly vary without resulting in a change in the basic function to which it is related. Accordingly, a value modified by a term or terms, such as “about”, “approximately” and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise. “Approximately” as applied to a particular value of a range applies to both values, and unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A system, comprising:
a memory; and
a processor coupled to the memory and configured to classify changes between graphic design system (GDS) files using a machine learning (ML) model according to a process that includes:
inputting a first GDS file and a second GDS file into a graphic design system exclusive or (GDSXOR) comparator to generate a differences file, wherein the differences file includes a plurality of changes between the first GDS file and a second GDS file;
using the ML model to process changes in the differences file, wherein the ML model evaluates each change and outputs a probability that a change is at least one of expected or unexpected; and
comparing the probability to a threshold and classifying the change as at least one of expected or unexpected in response to the threshold being met; and
a visualization system having a visualization interface configured to display the change in response to the threshold not being met and to receive a manual classification from a user that classifies the change as at least one of expected or unexpected, wherein displaying the change includes displaying two cells in a single window highlighting the change.

2. (canceled)

3. The system of claim 1, wherein in response to the threshold not being met, the process further comprises adding an update to a dataset used to train the ML model, and wherein the update includes the change and a label that includes the manual classification.

4. The system of claim 3, wherein the ML model is further trained with the dataset that includes the update.

5. The system of claim 3, wherein the process repeats until all changes in the differences file are classified.

6. The system of claim 5, wherein the first GDS file includes an original GDS file and the second GDS file includes a modified GDS file.

7. The system of claim 6, wherein changes classified as unexpected are addressed with manual alterations to the modified GDS file.

8. The system of claim 7, wherein the modified GDS file is utilized as a layout to build a device for an integrated circuit chip.

9. The system of claim 1, wherein changes in the differences files include image data.

10. The system of claim 1, wherein the ML model is initially trained according to a training process that includes:
providing a dataset of unclassified changes;
displaying unclassified changes in a visualization interface;
receiving labels from a user for the unclassified changes, wherein each label classifies an associated change as at least one of expected or unexpected; and
updating the dataset with the labels and associated changes.

11. A method for classifying changes between graphic design system (GDS) files using a machine learning (ML) model, the method comprising:
inputting a first GDS file and a second GDS file into a graphic design system exclusive or (GDSXOR) comparator to generate a differences file, wherein the differences file includes a plurality of changes between the first GDS file and a second GDS file;
using the ML model to process changes in the differences file, wherein the ML model evaluates each change and outputs a probability that a change is at least one of expected or unexpected;
comparing the probability to a threshold and classifying the change as at least one of expected or unexpected in response to the threshold being met;
displaying the change in a visualization interface, including displaying two cells in a single window highlighting the change; and
receiving a manual classification from a user that classifies the change as at least one of expected or unexpected.

12. (canceled)

13. The method claim 11, wherein in response to the threshold not being met, adding an update to a dataset used to train the ML model, and wherein the update includes the change and a label that includes the manual classification.

14. The method of claim 13, wherein the ML model is further trained with the dataset that includes the update.

15. The method of claim 13, wherein the method repeats until all changes in the differences file are classified.

16. The method of claim 15, wherein the first GDS file includes an original GDS file and the second GDS file includes a modified GDS file.

17. The method of claim 16, wherein changes classified as unexpected are addressed with manual adjustments to the modified GDS file.

18. The method of claim 17, wherein the modified GDS file is utilized as a layout to build a device for an integrated circuit chip.

19. The method of claim 11, wherein changes in the differences files include image data.

20. The method of claim 11, wherein the ML model is initially trained according to a training process that includes:
providing a dataset of unclassified changes;
displaying unclassified changes in a visualization interface;
receiving labels from a user for the unclassified changes, wherein each label classifies an associated change as at least one of expected or unexpected; and
updating the dataset with the labels and associated changes.
